(19) United States
(12) Patent Application Publication
(10) Pub. No.: US 2020/0302539 A1
(43) Pub. Date: Sep. 24, 2020

(54) PROJECT-BASED AND ENTERPRISE GROUP-BASED RISK MANAGEMENT METHOD, COMPUTER, AND NON-TRANSITORY COMPUTER-READABLE STORAGE MEDIUM

(71) Applicant: SUMITOMO MITSUI BANKING CORPORATION, Tokyo (JP)

(72) Inventors: Kiyonori UGAJIN, Tokyo (JP); Kazushige Onishi, Tokyo (JP)

(21) Appl. No.: 16/650,757

(22) PCT Filed: Sep. 29, 2017
(86) PCT No.: PCT/JP2017/035677

§ 371 Date: Mar. 25, 2020

(51) Int. Cl. G06Q 40/06; G06Q 10/06; G06Q 10/10

(52) U.S. Cl. CPC G06Q 40/06; G06Q 10/10; G06Q 10/0635

(57) ABSTRACT

Among the financial situations of the individual related parties involved in a structured finance project, not only the financial situation of a related party involved in a specific business but also the financial situation of each of its group companies in a business relationship, such as a capital relationship, with enterprises being related parties affect the financial institutions that are involved in the specific business and provide financing. With a computing system, related parties involved in a structured finance project and their group companies can be collectively managed and the range of a risk that arises due to the occurrence of a change in the financial situation of a related party or of a group company can be presented to main offices.

### TECHNICAL FIELD

The present invention relates to a project-based and enterprise group-based risk management method, computer and program. More specifically, the present invention relates to a project-based and enterprise group-based risk management method, computer and program capable of collectively managing related parties involved in a structured finance project and their group companies and presenting the range of a risk that arises due to the occurrence of a change in the financial situation of a related party or of a group company to main offices. The present invention also relates to a risk management method, computer, and program capable of, in a case of determining credit for an SPC (an abbreviation for special purpose company) applying for structured finance, figuring out the range of risks with its related parties and their group companies.

### BACKGROUND ART

Structured finance is one of financing services provided by financial institutions, in which an enterprise to be financed can separate their assets from their balance sheet and therefore enjoy advantages such as using the creditworthiness of the enterprise's assets, instead of the creditworthiness of the enterprise, to obtain a better loan. An example of structured finance is project finance. Project finance involves determining credit and providing financing for a specific business (e.g., a project for development of a resource such as petroleum), and using the cash flow generated by the business as a capital for the repayment. Financial institutions finance an SPC that handles only the specific business. The SPC is established by a plurality of enterprises to be involved in the specific business, and these enterprises will be referred to as related parties. The related parties also include enterprises involved in the specific business after the establishment of the SPC. Thus, a number of related parties are involved in a single specific business. For this reason, the financial situation of each individual related party greatly affects the outcome of the specific business and further the financial institutions that will receive the repayment from the cash flow to be generated by the specific business.

It is therefore very important for the financial institutions to manage the financial situation of each related party and figure out the range of a risk that arises due to the occurrence of a change in the financial situation. It is also necessary to figure out the range of risks with the related parties in the case of determining the credit for financing the SPC. In view of this, a credit management system described in PTL 1 manages specific businesses and related parties involved therein in association with each other and, in a case where the financial situation of a related party changes, notifies financial institutions of information on the specific business and the related parties that may be affected by the change.

### CITATION LIST

### Patent Literature

PTL 1: Japanese Patent No. 6130979

### SUMMARY OF INVENTION

In reality, however, not only the financial situation of a related party involved in a specific business but also the financial situation of each of its group companies in a business relationship, such as a capital relationship, with enterprises being related parties affect the financial institutions that are involved in the specific business and provide financing.

Also, there is a case where branch offices (main offices) of the financial institutions that make financial transactions with related parties and their group companies are located in a plurality of countries. In this case, data (client data) on the related parties and their group companies are distributed and managed in databases installed in the countries where the main offices are located. Thus, in reality, in a case where the financial situation of a related party or a group company changes, it will take a significant amount of work time to collect the client data on other related parties and group companies that may be affected by the change. Also, since the data collection is a manual operation, erroneous data collection and missing of data are possible, and thus the collected data cannot be said to be sufficiently reliable. Moreover, the main offices for the related parties and their group companies that may be affected need to be notified of their information, but this is also a manual operation and thus there is a sufficient possibility of errors and missing of data.

The present invention has been made in view of such problems, and an object thereof is to perform structured finance project-based and enterprise group-based risk management by collectively managing related parties involved in a structured finance project supported by financial institutions and their group companies and presenting the range of a risk that arises due to the occurrence of a change in the financial situation of a related party or a group company to main offices. The present invention is also intended to, in the case of determining credit for an SPC applying for structured finance, figure out the range of risks with its related parties and their group companies. Note that a part expressed herein as “financial institution” includes an entire financial holding company group and a company affiliated with it.

To achieve such objects, an aspect of the present invention provides a structured finance project-based and enterprise group-based risk management method characterized in that the method comprises:

obtaining project data on a project in which is involved a target client among clients contracting with a financial institution;

obtaining first client data on related parties involved in the project based on the project data;

obtaining second client data on group companies in groups to which the related parties belong based on the first client data; and

generating risk propagation data indicating risk propagation originating from the target client based on the project data, the first client data, and the second client data.

Also, in another embodiment, an aspect of the present invention provides a computer for performing structured finance project-based and enterprise group-based risk management, characterized in that the computer is configured to:

obtain project data on a project in which is involved a target client among clients contracting with a financial institution;

obtain first client data on related parties involved in the project based on the project data;

obtain second client data on group companies in groups to which the related parties belong based on the first client data; and

generate risk propagation data indicating risk propagation originating from the target client based on the project data, the first client data, and the second client data.

In still another embodiment, an aspect of the present invention provides a computer program for causing a computer to perform structured finance project-based and enterprise group-based risk management, characterized in that, in a case where the computer program is executed by the computer, the computer program causes the computer to:

obtain project data on a project in which is involved a target client among clients contracting with a financial institution;

obtain first client data on related parties involved in the project based on the project data;

obtain second client data on group companies in groups to which the related parties belong based on the first client data; and

generate risk propagation data indicating risk propagation originating from the target client based on the project data, the first client data, and the second client data.

### Advantageous Effects of Invention

As described above, according to the present invention, with a computing system, related parties involved in a structured finance project and their group companies can be collectively managed and the range of a risk that arises due to the occurrence of a change in the financial situation of a related party or of a group company can be presented to main offices. Also, in the case of determining credit for an SPC applying for structured finance, the range of risks with its related parties and their group companies can be figured out.

### BRIEF DESCRIPTION OF DRAWINGS

FIG. 1 is a diagram illustrating the configuration of the entirety of a system according to an embodiment of the present invention;

FIG. 2 is a diagram illustrating the configuration of a risk management server being a main server in the system according to the embodiment of the present invention;

FIG. 3 is a flowchart illustrating a risk management process according to an embodiment of the present invention;

FIG. 4 is a diagram illustrating data stored in a project data storage unit according to an embodiment of the present invention;

FIG. 5 is a diagram illustrating data stored in a related party data storage unit according to an embodiment of the present invention;

FIG. 6 is a diagram illustrating data stored in a client data storage unit according to an embodiment of the present invention;

FIG. 7 is a diagram illustrating data stored in a group data storage unit according to an embodiment of the present invention;

FIG. 8 is a diagram illustrating data stored in a risk propagation data storage unit according to an embodiment of the present invention;

FIG. 9 is a diagram illustrating a risk check screen according to an embodiment of the present invention; and

FIG. 10 is a diagram illustrating a group check screen according to an embodiment of the present invention.

### DESCRIPTION OF EMBODIMENTS

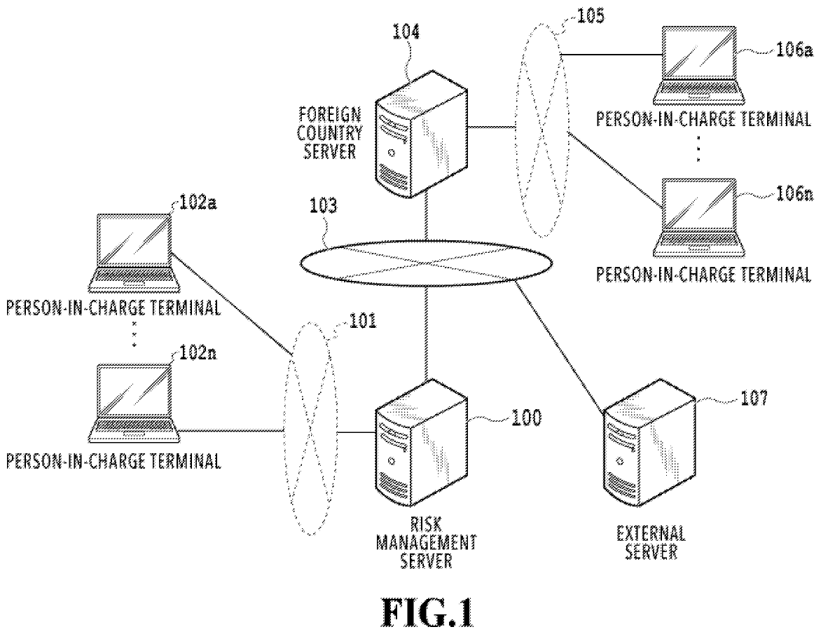

A system according to an embodiment of the present invention will be described below in detail with reference to the accompanying drawings. FIG. 1 is a diagram illustrating the configuration of the entirety of a system according to an embodiment of the present invention. In FIG. 1, a risk management server 100 being a main server in the system and installed in a data center or the like in a country A (e.g., Japan) is configured to perform communication with person-in-charge terminals 102a to 102n (hereinafter collectively referred to as “person-in-charge terminals 102”) used by persons in charge in branch offices in the country A through a network 101 (e.g., intranet). The risk management server 100 is also configured to perform communication with a foreign country server 104 and an external server 107 through a network 103 (e.g., the Internet). The foreign country server 104, which is installed in a country B (e.g., the United States), is also configured to perform communication with person-in-charge terminals 106a to 106n (hereinafter collectively referred to as “person-in-charge terminals 106”) used by persons in charge in branch offices in the country B through a network 105 (e.g., intranet). Note that each server computer, such as the risk management server 100, is illustrated as a single server computer in FIG. 1 but can be constructed as a distributed computing system with a plurality of server computers. Also, although the person-in-charge terminals in only two countries are illustrated in FIG. 1, there are actually person-in-charge terminals at many branch offices in many countries.

The risk management server 100 is a server computer managed by financial institutions in the country A and holds client data on clients in the country A. The risk management server 100 is an entity for the execution of a risk management process in the present invention. In a case where the financial situation of a client changes or in a case where there is a request for a risk check on a client, the risk management server 100 obtains a piece of project data related to the target client and obtains pieces of client data on related parties including the target client and their group companies. Also, the risk management server 100 generates risk propagation data based on the piece of project data and the pieces of client data thus obtained. The risk management server 100 then determines main offices to which to issue a risk notice, and issues the risk notice to the target main offices.

The foreign country server 104 is a server computer managed by financial institutions in the country B and holds client data on clients in the country B. The foreign country server 104 in FIG. 1 is illustrated as serving as a server for relaying data from the risk management server 100 in the country A to the person-in-charge terminals 106 in the country B, but the foreign country server 104 can be equipped with the same functions as those of the risk management server 100 and execute the risk management process to be described later.

The person-in-charge terminals 102 and the person-in-charge terminals 106 are terminals used by persons in charge in the financial institutions in the respective countries. A person in charge in each country transmits a request for a risk check on a client to the risk management server 100 via his or her person-in-charge terminal 102 or person-in-charge terminal 106 in the case of determining credit, for example. Also, a person in charge in each country receives a risk notice from the risk management server 100 and accesses the risk propagation data via his or her person-in-charge terminal 102 or person-in-charge terminal 106.

The external server 107 is a server computer managed by an institution other than the financial institutions, and manages data on the financial situations of enterprises, changes in inter-enterprise capital relationships, and so on, and provides these data to the financial institutions.

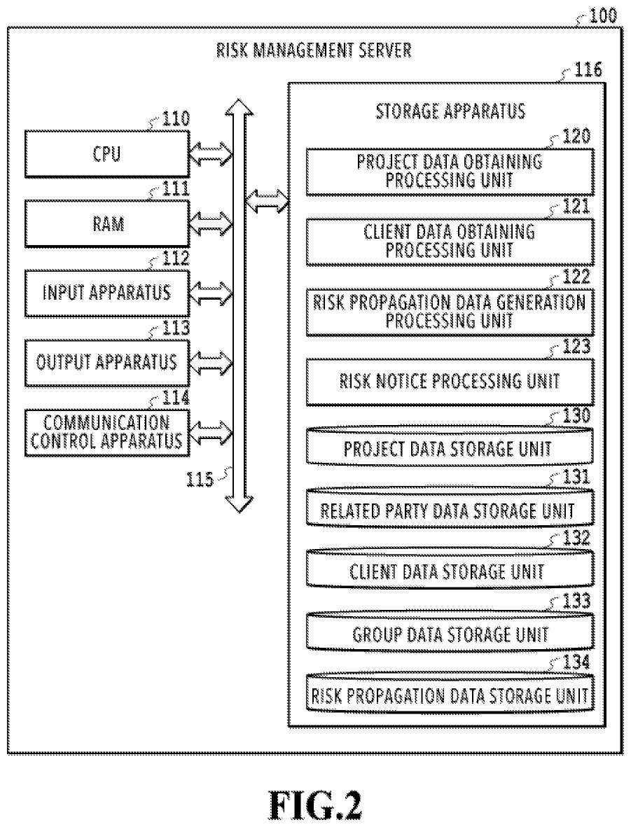

Next, the configuration of the risk management server 100 will be described in detail. FIG. 2 is a diagram illustrating the configuration of the risk management server being a main server in the system according to the embodiment of the present invention. Note that FIG. 2 assumes a single server computing system and illustrates only the necessary components. The risk management server 100 includes a CPU 110, a RAM 111, an input apparatus 112, an output apparatus 113, a communication control apparatus 114, and a storage apparatus 116 which are connected to one another via a system bus 115. The storage apparatus 116 includes a non-volatile storage medium (such as a ROM or HDD), and has a program storage area storing a software program related to transfer processing, and a data storage area storing data to be used in the software program. Each of the later-described processing units in the program storage area is actually an independent software program, its routine, component, or the like and is stored in the storage apparatus 116. Each processing unit is capable of exhibiting its function while accessing a database or the like as appropriate by being called from the storage apparatus 116 and deployed in a work area in the RAM 111 to be implemented by the CPU 110.

The software program stored in the program storage area in the storage apparatus 116 in FIG. 2 includes a project data obtaining processing unit 120, a client data obtaining processing unit 121, a risk propagation data generation processing unit 122, and a risk notice processing unit 123, which are listed as only processing units relevant to the present invention. These processing units are implemented by the CPU 110.

The data storage area in the storage apparatus 116 in FIG. 2 includes a project data storage unit 130, a related party data storage unit 131, a client data storage unit 132, a group data storage unit 133, and a risk propagation data storage unit 134, which are listed as only storage units relevant to the present invention. Each storage unit is a certain storage area allocated in the storage apparatus 116.

Next, the functions of the software program stored in the storage apparatus 116 in FIG. 2 will be described. The project data obtaining processing unit 120 in FIG. 2 monitors whether the financial situation of any client changes and, in a case where the financial situation changes or a request for a risk check on a target client is received, obtains the piece of project data related to the target client from the project data storage unit 130. None that a single client may be involved in a plurality of projects. Thus, there is a possibility that a plurality of pieces of project data are obtained for a single client.

Based on the obtained piece of project data, the client data obtaining processing unit 121 in FIG. 2 obtains pieces of related party data indicating the relation between the project and the related parties involved therein from the related party data storage unit 131. Also, the client data obtaining processing unit 121 obtains pieces of data (client data) on the related parties from the client data storage unit 132 based on the obtained pieces of related party data. Further, the client data obtaining processing unit 121 obtains pieces of group data indicating inter-enterprise group relationships from the group data storage unit 133 based on the obtained pieces of client data. Furthermore, the client data obtaining processing unit 121 obtains pieces of data (client data) on the group companies of the related parties from the client data storage unit 132 based on the obtained pieces of group data.

The risk propagation data generation processing unit 122 in FIG. 2 generates risk propagation data originating from the target client based on the obtained piece of project data and the obtained pieces of data (client data) on the related parties and the group companies, and stores it in the risk propagation data storage unit 134.

The risk notice processing unit 123 in FIG. 2 determines main offices to which to issue a risk notice, and issues the risk notice to the target main offices.

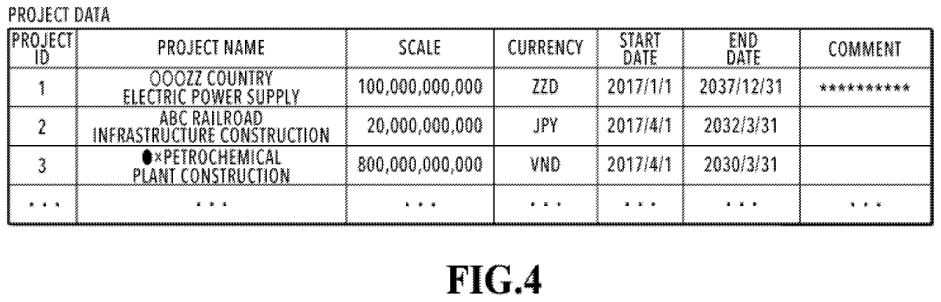

Next, the pieces of data stored in the storage apparatus 116 in FIG. 2 will be described in detail. The project data storage unit 130 in FIG. 2 stores data on structured finance projects being financing targets for the financial institutions. FIG. 4 is a diagram illustrating data stored in the project data storage unit 130 according to an embodiment of the present invention.

Each piece of project data in FIG. 4 can store “project ID” uniquely indicating a project, “project name” indicating the name of the project, “scale” and “currency” indicating the scale (e.g., capital) of the project and its currency unit, “start date” and “end date” indicating the start date and the end date of operation of the project, and “comment” indicating a comment(s) on the project, for example.

Each piece of project data in FIG. 4 is transaction data generated by the risk management server 100 or the foreign country server 104 upon application for structured finance by a client. The “project ID” is a sequential number assigned at the time of generating the data, for example. The “currency” is a currency unit, and an identification code indicating the currency unit, such as “JPY” (Japanese yen), is stored (note that “ZZD” is a fictitious currency unit).

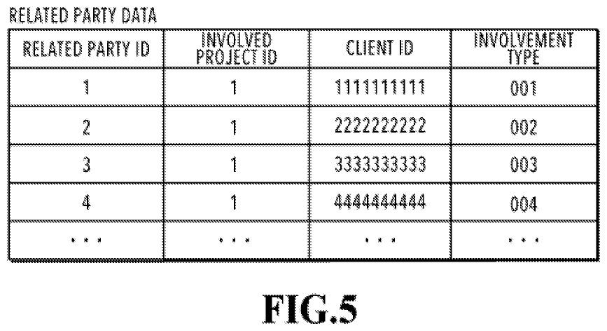

The related party data storage unit 131 in FIG. 2 stores data on the related parties involved in projects. FIG. 5 is a diagram illustrating data stored in the related party data storage unit 131 according to an embodiment of the present invention.

Each piece of related party data in FIG. 5 can store “related party ID” uniquely indicating a related party, “involved project ID” uniquely indicating the project in which the related party is involved, “client ID” uniquely indicating a client being the related party, and “involvement type” indicating how the related party is involved in the project, for example.

Each piece of related party data in FIG. 5 is transaction data generated along with the corresponding piece of project data (FIG. 4). The “related party ID” is also a sequential number assigned at the time of generating the data, for example. As the “involved project ID”, the “project ID” in the corresponding piece of project data (FIG. 4) indicating the project in which the related party is involved is set. This enables the piece of related party data and the piece of project data to be associated with each other. The “related party ID” and the “client ID” both indicate a related party. There is a case where a single client is involved in different projects. In this case, generated are a plurality of pieces of data containing the same “client ID” but different “related party IDs”. As the “involvement type”, an identification code can be set which indicates how the related party is involved in the project (e.g., 001: fuel supply contractor, 002: power selling contractor, 003: construction contractor, 004: facility equipment supply contractor, . . . ).

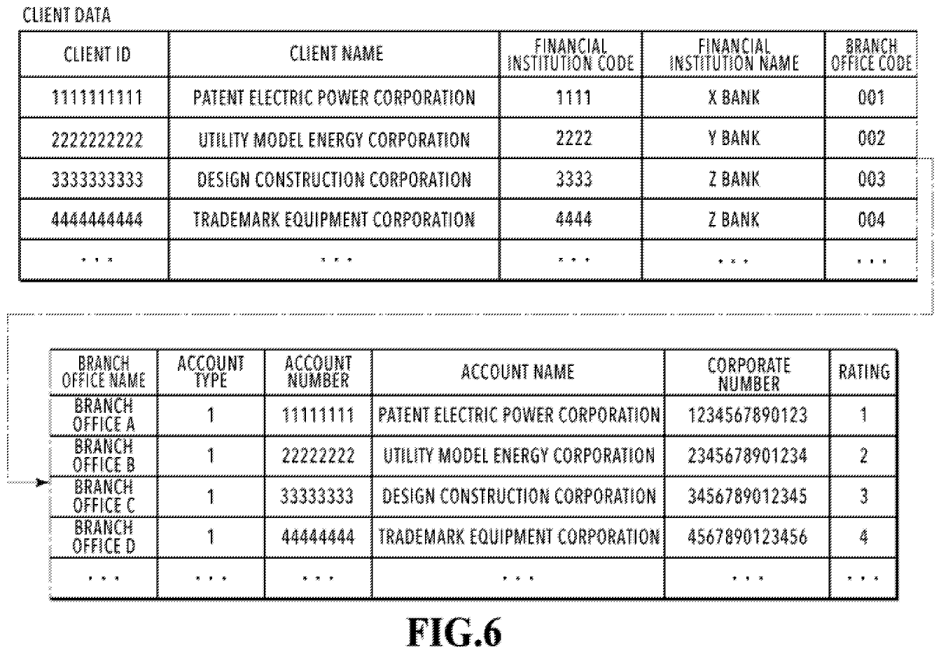

The client data storage unit 132 in FIG. 2 stores data on clients contracting with the financial institutions. FIG. 6 is a diagram illustrating data stored in the client data storage unit 132 according to an embodiment of the present invention.

each piece of client data in FIG. 6 can store “client ID” uniquely indicating a client, “client name” indicating the name of the client, “financial institution code” and “financial institution name” indicating an identification code uniquely indicating a financial institution that makes a financial transaction with the client and the name of that financial institution, “branch office code” and “branch office name” indicating an identification code uniquely indicating the branch office (main office) of the financial institution that makes the financial transaction with the client and the name of that branch office, “account type” uniquely indicating the account type (category) of the contract account of the client, “account number” and “account name” indicating the account number of the contract account and its account name, “Corporate Number” indicating the corporate number of the client issued by the National Tax Agency, and “rating” indicating a rating on the client, for example.

each piece of client data in FIG. 6 is master data on a contracting client generated and managed by its financial institution. The “client ID” is also a sequential number assigned at the time of generating the data, for example. An identification code indicating the account type of the client's contract account (e.g., 1: savings account, 2: time deposit, 3: checking account, . . . ) can be set as the “account type”. The “rating” is, for example, a 13-point scale rating set based on the financial institution's own rule, and an identification code can be set with “1” representing the highest rating and “DF (default)” representing the lowest rating.

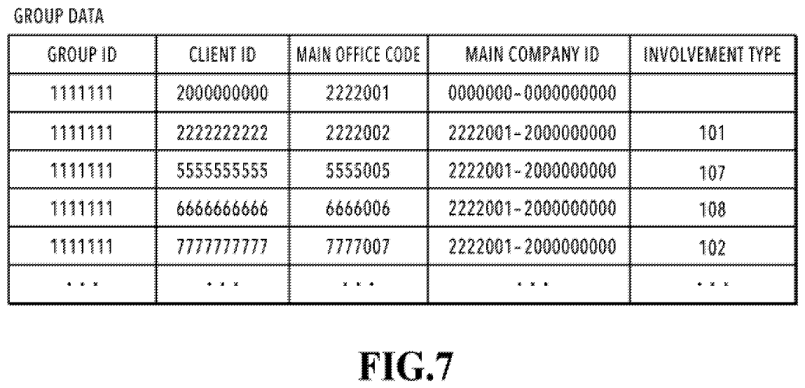

The group data storage unit 133 in FIG. 2 stores data on the group relationship between enterprises (between a main company and its associated companies). FIG. 7 is a diagram illustrating data stored in the group data storage unit 133 according to an embodiment of the present invention.

Each piece of group data in FIG. 7 can store “group ID” uniquely indicating a group of enterprises, “client ID” uniquely indicating a client belonging to the group, “main office code” uniquely indicating the main office that makes a financial transaction with the client, “main company ID” uniquely indicating a main company on the assumption that the client indicated by the “client ID” is its associated company, and “association type” indicating the type of association between the client (associated company) and the main company, for example.

Each piece of group data in FIG. 7 is master data managed by the corresponding financial institution to maintain the latest status of the inter-enterprise relationship. Clients with the same “group ID” mean that they belong to the same group. As the “client ID”, the “client ID” in the corresponding piece of client data (FIG. 6) is set. This enables the piece of group data and the piece of client data to be associated with each other. Note that FIG. 7 is a diagram illustrating, as one embodiment, the relationship of the associated company indicated by each “client ID” with the main company indicated by the corresponding “main company ID”. In another embodiment, FIG. 7 can be a diagram illustrating the relationship of each main company with its associated company by setting an ID indicating the main company as the “client ID” and replacing the “main company ID” with “associated company ID” indicating the associated company.

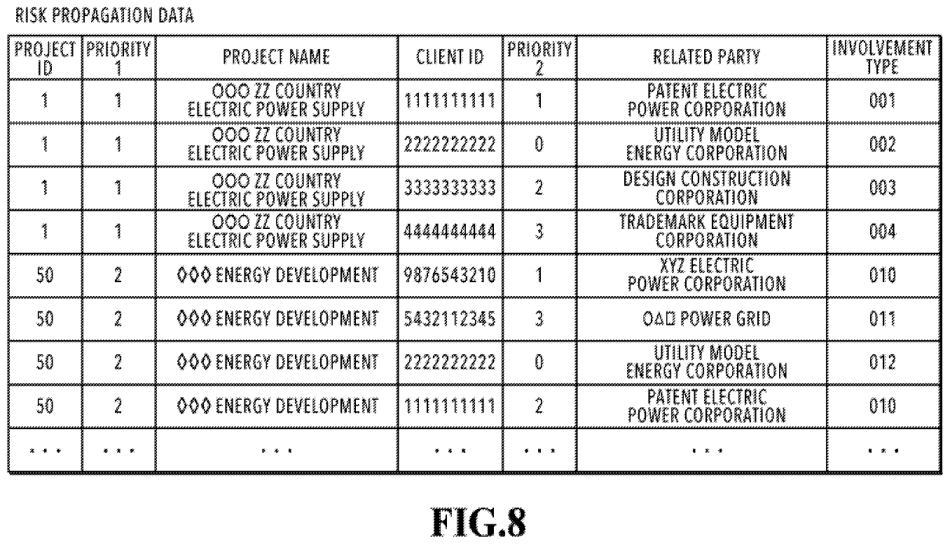

The “main company ID” in FIG. 8 is an identification code uniquely indicating a main company on the assumption that the client indicated by the “client ID” is its associated company. As illustrated in FIG. 7, the “main company ID” is generated by, for example, combining the “main office code” and the “client ID” of the main company. Note that in a case where the client indicated by the “client ID” is a main company, there is no main company for that client. Thus, for example, dummy data, such as “0000000-0000000000”, can be set as the “main company ID”, as illustrated in FIG. 7, to indicate that the client indicated by the “client ID” is the main company among the clients with the same “group ID”. For example, the relationship between the pieces of data with the “group ID” of “1111111” in FIG. 7 is such that the client with the “client ID” of “2000000000” is the main company and the others are its associated companies.

As the “association type” in FIG. 8, an identification code can be set which indicates the type of association of the associated company indicated by the “client ID” with its main company (e.g., 101: in capital relationship, 102: share issuer, 103: in personal relationship, 104: supplier, 105: buyer, 106: guarantee, 107: equity method subsidiary, 108: investee, 109: company under de facto control, . . . ). Note that in the case where the client indicated by the “client ID” is a main company, empty data or the like can be set as the “association type”, as illustrated in FIG. 7. Alternatively, it is possible to not provide the “association type” in FIG. 8 or to additionally provide a data item for determining the inter-enterprise relationship (e.g., stake) and determine the association type as necessary.

The risk propagation data storage unit 134 in FIG. 2 stores data on risk propagation originating from a target client. FIG. 8 is a diagram illustrating data stored in the risk propagation data storage unit 134 according to an embodiment of the present invention.

Each piece of risk propagation data in FIG. 8 can store “project ID” uniquely indicating a project, “priority 1” indicating the priority of the project among a plurality of projects, “project name” indicating the name of the project, “client ID” uniquely indicating a client being a related party involved in the project, “priority 2” indicating the priority of the related party in the same project, “related party” indicating the name of the related party, and “involvement type” indicating how the related party is involved in the project, for example.

Each piece of risk propagation data in FIG. 8 is transaction data generated by the risk management server 100 or the foreign country server 104 based on the piece of project data (FIG. 4) related to the target client and so on. The “project ID” is obtained from the piece of project data in which the target client is a related party. As illustrated in FIG. 8, there are a plurality of projects (“project ID”=“1” and “50”) in the case where the target client is a related party involved in the plurality of projects. The “priority 1” is the priority of the project in the case where there is a plurality of projects and, for example, a smaller number indicates higher priority. As for the “priority 1”, a project which has a larger “scale” in the project data and in which the target client is involved to a greater extent is considered to have a higher risk, and its priority can thus be set at a higher level.

The “client ID”, the “related party”, and the “involvement type” in FIG. 8 are obtained from the piece of related party data (FIG. 5) associated with the piece of project data (FIG. 4) related to the target client (more precisely, the “related party” is the “client name” in the piece of client data (FIG. 6) further associated with it). The “priority 2” is the priority of the related party within the same project and, for example, a smaller number indicates higher priority. In the example of FIG. 8, the “priority 2” of the target client is “0” (highest priority). The “priority 2” of each of the other related parties is set based on its “involvement type”, the extent of involvement of the related party in the project, and so on.

Note that the risk propagation data in FIG. 8 does not contain data on the group companies of any related parties, in consideration of complication of the illustration. In practice, however, the risk propagation data needs to further contain the group companies of the related parties. Thus, based on the pieces of group data (FIG. 7) associated with the “client IDs” in the risk propagation data indicating the related parties, the pieces of data (client data) on the group companies of the related parties are obtained and combined to form the risk propagation data.

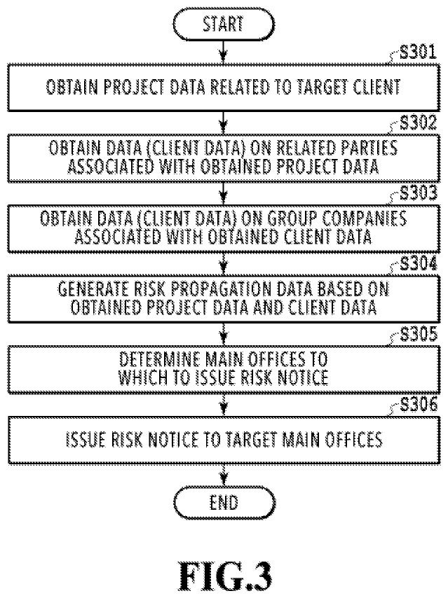

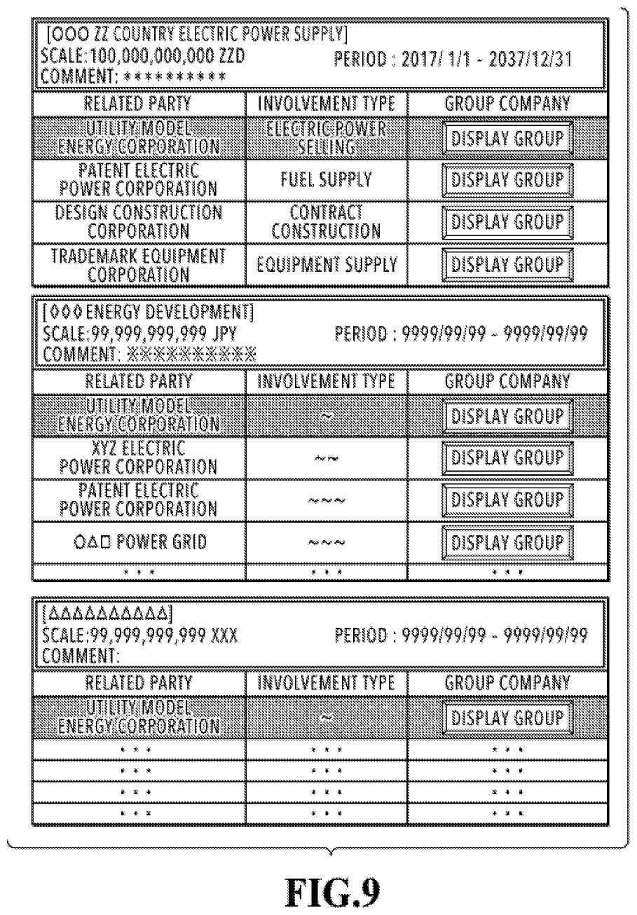

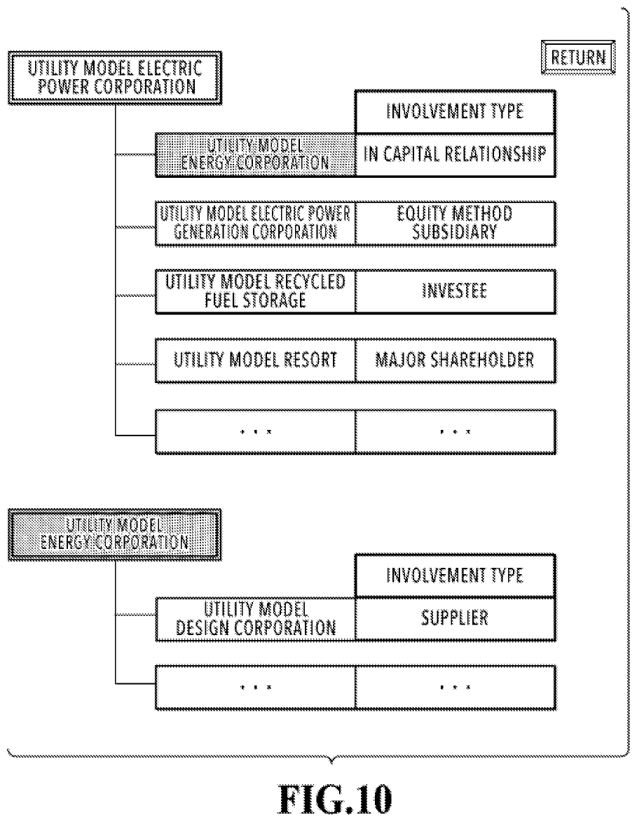

Next, the risk management process according to an embodiment of the present invention will be described along its flow with reference to the flowchart in FIG. 3, the pieces of data in FIGS. 4 to 8, and the user interfaces in FIGS. 9 and 10. FIG. 3 is a flowchart illustrating the risk management process according to an embodiment of the present invention. This process is performed by the risk management server 100 or foreign country server 104 in response to the occurrence of a change in the financial situation of any of clients or receipt of a request for a risk check on a target client as a trigger to obtain the piece of project data and the pieces of related party data related to the target client and the pieces of group data on the related parties, generate risk propagation data, and issue a risk notice to main offices. “The occurrence of a change in the financial situation of any of clients” as a trigger for this process refers to the occurrence of a change in the financial situation of any of clients observed by the risk management server 100 or the foreign country server 104 by regularly monitoring whether the financial situation changes, or to the satisfaction of a predetermined condition by the change in the financial situation (such as bankruptcy of the target client or reduction of the rating or sales of the target client to below a certain level). On the other hand, the “receipt of a request for a risk check on a target client” refers to the receipt of request data (not illustrated) for a risk check on the target client from a person-in-charge terminal 102 or a person-in-charge terminal 106 in the case of determining credit, for example.

Next, the flowchart in FIG. 3 will be described in detail. Firstly, the project data obtaining processing unit 120 obtains the piece of project data (FIG. 4) related to the target client from the project data storage unit 130 (step 301). Specifically, the project data obtaining processing unit 120 associates the “project IDs” in the project data and the “involved project IDs” in the related party data (FIG. 5) with each other and searches through the “clients ID” in the related party data with the target client as a search key to obtain the associated piece of project data. In the case where the target client is involved in a plurality of projects, a plurality of pieces of project data are obtained.

Then, based on the piece of project data obtained in step 301, the client data obtaining processing unit 121 obtains the pieces of data (client data) on the related parties associated with the obtained piece of project data from the client data storage unit 132 (step 302). The pieces of data obtained here are the pieces of client data (FIG. 6) on the related parties involved in the project in which the target client is involved (including the target client). Specifically, the client data obtaining processing unit 121 obtains the pieces of client data by searching through the “client IDs” in the client data with the “client IDs” in the related party data (FIG. 5) associated with the “project ID” in the obtained piece of project data (FIG. 4) as search keys.

Then, based on the pieces of client data obtained in step 302, the client data obtaining processing unit 121 obtains the pieces of data (client data) on the group companies associated with the obtained pieces of client data from the client data storage unit 132 (step 303). The pieces of data obtained here are the pieces of client data (FIG. 6) on the group companies of the related parties involved in the project in which the target client is involved. Specifically, the client data obtaining processing unit 121 searches through the “client IDs” in the group data (FIG. 7) with the “client ID” in each obtained piece of client data (i.e., each related party) as a search key and obtains the corresponding “group ID” (i.e., searches for the group to which the related party belongs. The “group IDs” is obtained for each related party, and in the case where a related party belongs to a plurality of groups, as many group IDs as the number of the belonging groups are obtained for the one related party.

Then, based on the piece of project data and the pieces of related party data obtained in step 301 and the pieces of client data obtained in steps 302 and 303, the risk propagation data generation processing unit 122 generates risk propagation data (FIG. 8) and stores it in the risk propagation data storage unit 134 (step 304). Specifically, the risk propagation data is generated by combining the piece of project data (FIG. 4) obtained in step 301 as a base to the pieces of related party data (FIG. 5) associated with this piece of project data and the pieces of client data (FIG. 6) obtained in step 302. Note that, as mentioned earlier, the risk propagation data in FIG. 8 does not contain data on the group companies of any related parties, in consideration of complication of the illustration. Thus, in practice, the pieces of data (client data) on the group companies of the related parties are also obtained from the client data storage unit 132 and combined to form the risk propagation data.

Then, the risk notice processing unit 123 determines main offices to which to issue a risk notice (step 305). Specifically, the branch offices indicated by the “financial institution codes” and the “branch office codes” in the pieces of client data (FIG. 6) obtained in steps 302 and 303 are the main offices for the related parties and their group companies. Thus, the risk notice processing unit 123 determines these branch offices as the main offices to which to issue a risk notice. In another embodiment, instead of determining all of these branch offices as the notifying targets, the main offices for those clients satisfying a predetermined condition (such as being involved in a project with a scale above a predetermined level and thus having a very high risk) as the notifying targets based on data such as the “scale” in the pieces of project data (FIG. 4).

Then, the risk notice processing unit 123 issues a risk notice to the target main offices determined in step 305 (step 306). Specifically, the risk notice processing unit 123 issues the notice to terminals such as the person-in-charge terminals 102 or person-in-charge terminals 106 at the target main offices via display of an alert, e-mail, or the like. The persons in charge receiving the notice via the person-in-charge terminals 102 or the person-in-charge terminals 106 or the like access the risk propagation data generated in step 304 via the person-in-charge terminals 102 or the person-in-charge terminals 106. The risk propagation data can be accessed from the risk check screen (FIG. 9) and the group check screen (FIG. 10) to be described next in detail by logging in to a dedicated website provided by the risk management server 100 or the foreign country server 104, for example. After step 306, this process is terminated.

A description will be given of the risk check screen for a person in charge receiving the risk notice in step 306 to check the risk via the person-in-charge terminal 102 or the person-in-charge terminal 106 or the like. FIG. 9 is a diagram illustrating the risk check screen according to an embodiment of the present invention. FIG. 9 corresponds to the risk propagation data in FIG. 8 and lists three projects at risk with respect to the target client and the related parties involved therein. The target client indicated by “priority 2”=“0” (highest priority) can be highlighted with shading and bold characters, for example (the related party “Utility Model Energy Corporation” in the example of FIG. 9). The projects and the related parties involved therein can be displayed based on the “priority 1” and the “priority 2” in the risk propagation data (FIG. 8) such that the higher the priority of the project or the related party, the higher its position.

The group display button on the right of each related party section in FIG. 9 can be pressed with a mouse click or the like to display a group check screen for checking the group companies of the corresponding related party. FIG. 10 is a diagram illustrating the group check screen according to an embodiment of the present invention. In the example of FIG. 10, the group companies of the related party “Utility Model Energy Corporation” in FIG. 9 are displayed. In FIG. 10, the related party “Utility Model Energy Corporation”, for example, is highlighted with shading and bold characters and displayed as belonging to two groups. In the upper group, the related party “Utility Model Energy Corporation” is displayed as being an associated company of a main company “Utility Model Electric Power Corporation” and in a capital relationship with it. In the lower group, on the other hand, the related party “Utility Model Energy Corporation” is the main company and is displayed as having an associated company “Utility Model Design Corporation” as a supplier. Pressing the return button in FIG. 10 brings the screen back to the risk check screen in FIG. 9, and pressing the group display button in another related party section displays the group check screen (FIG. 10) for the group companies of another related party.

In the risk check screen (FIG. 9) and the group check screen (FIG. 10), the range of risk propagation is represented as the target client→the related parties involved in the projects in which the target client is involved→the group companies of each of the related parties (type 1). Note, however, that other embodiments as below are also conceivable. For example, the range of risk propagation may be represented as the target client→the group companies in the groups to which the target client belongs→the related parties involved in the projects in which the group companies are involved (type 2), or a combination of the type 1 and the type 2. Further, the range of risk propagation can be widened such that the risk propagation data covers up to the related parties involved in the projects in which the group companies of each related party in type 1 are involved, for example. Furthermore, the risk propagation data can cover up to the related parties involved in other projects in which the related parties are involved and the group companies in other groups to which the group companies belong. Moreover, the range of risk propagation that determines the range of the risk propagation data can be controlled collectively on a range basis or according to the level of the risk (e.g., the scale of the related projects and/or the extents of involvement of the clients in the projects and their enterprise groups. This enables weighting of the projects and the enterprise groups and therefore enables a risk check and management suitable for the situation.

According to the above, with a computing system, related parties involved in a structured finance project and their group companies can be collectively managed and the range of a risk that arises due to the occurrence of a change in the financial situation of a related party or of a group company can be presented to main offices. Also, in the case of determining credit for an SPC applying for structured finance, the range of risks with its related parties and their group companies can be figured out.

1. A structured finance project-based and enterprise group-based risk management method performed by a computer, the method comprises:
monitoring, by the computer, changes in a financial situation of a target client among clients contracting with a financial institution or receiving a request data for a risk check on the target client;
if the changes in the financial situation satisfies the predetermined condition or the request data is received, obtaining, by the computer, project data on a project previously associated with the target client;
obtaining, by the computer, first client data on related parties previously associated with the obtained project data;
obtaining, by the computer, second client data on group companies in groups to which the related parties belong, the second client data being previously associated with the obtained first client data; and
generating, by the computer, risk propagation data indicating risk propagation originating from the target client based on the obtained project data, the obtained first client data, and the obtained second client data.

2. The method according to claim 1, further comprising:
determining, by the computer, a main office to which to issue a risk notice, based on the obtained first client data and the obtained second client data; and
issuing, by the computer, the risk notice to the determined main office for accessing the risk propagation data from the main office.

3. (canceled)

4. The method according to claim 1, wherein the generation of the risk propagation data is further based on at least one of a scale of the project, extents of involvement of the related parties in the project, and extents of involvement of the group companies in the group.

5. A computer for performing structured finance project-based and enterprise group-based risk management, when the computer is configured to:
monitor changes in a financial situation of a target client among clients contracting with a financial institution or receive a request data for a risk check on the target client;
if the changes in the financial situation satisfies the predetermined condition or the request data is received, obtain project data on a project previously associated with the target client;
obtain first client data on related parties previously associated with the obtained project data;
obtain second client data on group companies in groups to which the related parties belong, the second client data being previously associated with the obtained first client data; and
generate risk propagation data indicating risk propagation originating from the target client based on the obtained project data, the obtained first client data, and the obtained second client data.

6. A non-transitory computer-readable storage medium having computer-executable instructions which causes, when executed by a processor, the processor to perform a method comprising:
monitor changes in a financial situation of a target client among clients contracting with a financial institution or receive a request data for a risk check on the target client;
if the changes in the financial situation satisfies the predetermined condition or the request data is received, obtain project data on a project previously associated with the target client;
obtain first client data on related parties previously associated with the obtained project data;
obtain second client data on group companies in groups to which the related parties belong, the second client data being previously associated with the obtained first client data; and
generate risk propagation data indicating risk propagation originating from the target client based on the obtained project data, the obtained first client data, and the obtained second client data.
